(19) United States
(12) Patent Application Publication
(10) Pub. No.: US 2009/0183087 A1
(43) Pub. Date: Jul. 16, 2009

(54) Method and Apparatus for Real Time Image Transfer Between Two or More Computers

(75) Inventor: David Robins, Chestnut Hill, MA (US)

Correspondence Address: David R. Robins, 22217 Hollyhock Trail, Boca Raton, FL, 33433, US

(73) Assignee: Binfire Corpoartion, Boca Raton, FL (US)

(21) Appl. No.: 12/329,592

(22) Filed: Dec. 7, 2008

Related U.S. Application Data
(60) Provisional application No. 61/020,225, filed on Jan. 10, 2008.

(51) Int. Cl. G06F 3/048

(52) U.S. Cl. 715/751

(57) ABSTRACT

This invention involves a method and computer memory apparatus for transmitting a portion of one computer screen to another remote computer screen in real time. The user of a transmitting computer might initiate a computer program that allows the user of the transmitting computer to select a portion of the screen to transmit to a user of a receiving computer. The user of the receiving computer then receives a window on the receiving computer's screen, wherein a possibly resized copy of the image on the transmitting computer's screen is displayed. The image might be displayed in real time, and the users of both or one of the transmitting and the receiving computers might be able to modify the content of the image.

### CROSS-REFERENCE TO RELATED APPLICATIONS

This application claims priority from U.S. Provisional Patent Application No. 61,020,225, filed on Jan. 10, 2008.

### DESCRIPTION OF THE DRAWINGS

FIG. 1 depicts a view of a user selected area on a transmitting computer screen in one embodiment of the invention.

FIG. 2 depicts a view of a window created on a receiving computer screen in one embodiment of the invention.

FIG. 3 depicts a possible software protocol for a transmitting computer in one embodiment of the invention.

FIG. 4 depicts a possible software protocol for a receiving computer in one embodiment of the invention.

FIG. 5 depicts a possible software protocol for a transmitting computer running a multi-computer broadcast in one embodiment of the invention.

FIG. 6 depicts a possible software protocol for transmitting input obtained on a receiving computer from a receiving computer to a transmitting computer in one embodiment of the invention. This software protocol allows for data obtained from a receiving computer to be processed or stored on a transmitting computer.

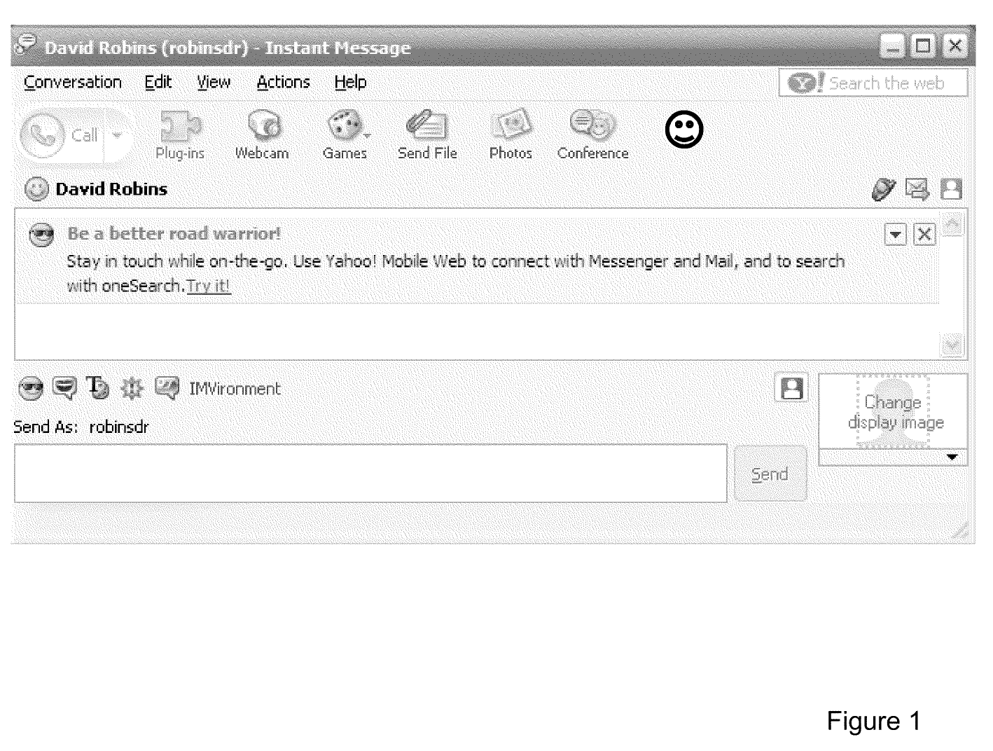

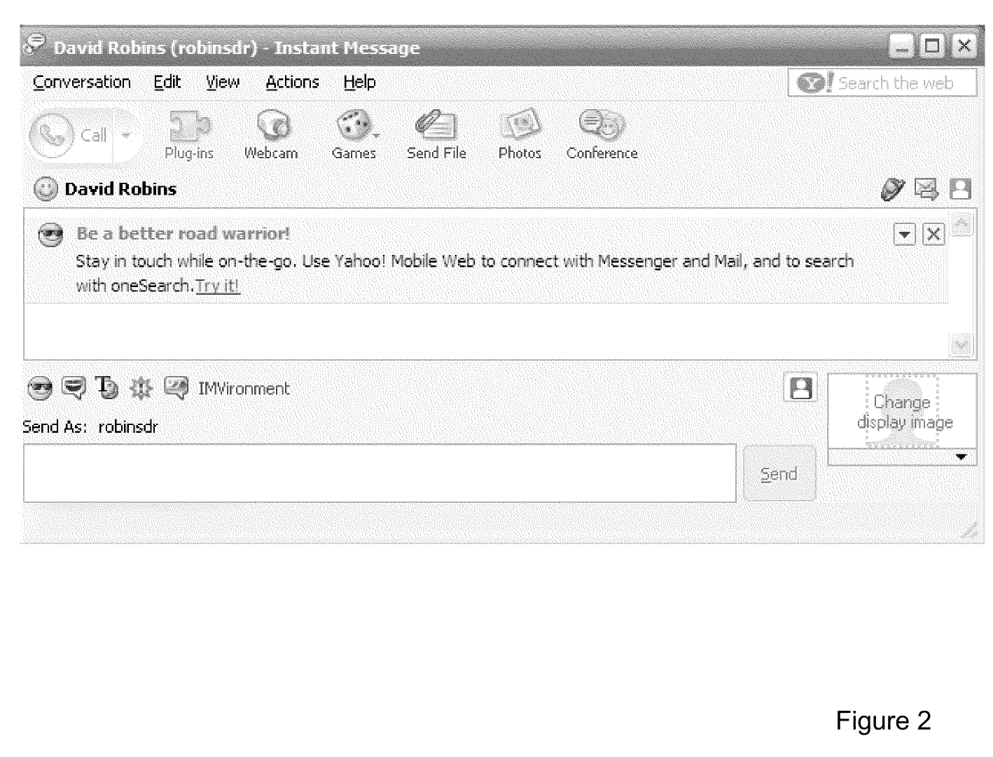

### BACKGROUND OF THE INVENTION

This invention is related to the computer arts. It involves a method and computer memory apparatus for transmitting a portion of one computer screen to another remote computer screen in real time.

### BRIEF SUMMARY OF THE INVENTION

This invention comprises two broad portions.

The first broad portion of the invention allows two substantially arbitrary computers—a substantially arbitrary transmitting computer and a substantially arbitrary receiving computer—to share a portion of their screens in real time. In this document, the term “computer” refers to any machine comprising a screen, a keyboard, and a processor. Thus “computer” might refer to a personal computer having a substantially arbitrary operating system, or a cellular telephone, blackberry, PDA, etc., all of which have screens, keyboards, and processors. The computers may be connected to each other through any medium that allows for two-way communication. Persons having ordinary skill in the relevant art are familiar with such mediums. For example, the connection can be achieved through a network connection, such as an internet connection, a cellular connection, or a telephone connection. Alternatively, the connection can be achieved through a wired or wireless connection. Wired connections include Ethernet, USB wires, etc. Wireless connections include radio, Bluetooth, commercial wireless routers, etc.

After the two computers are connected, the user of the transmitting computer might select an area of the screen of the transmitting computer, which he wishes to share with the user of the receiving computer. The user might communicate his intent to initiate this sharing through a text chat program or through a voice or video chat program. The screen sharing program itself might either be embedded in a chat program, or it could be run as a stand alone application. Alternatively, the screen sharing session could be initiated through the screen sharing program, and arranged in advance. After the user of the transmitting computer selects an area of the screen of the transmitting computer and signals his desire to begin the screen sharing to the user of the receiving computer, the user of the receiving computer may accept the screen sharing session. A window might then be formed on the screen of the receiving computer, comprising a pixel image of the contents of the selected area of the screen of the transmitting computer. Since the screen of the receiving computer might not have the same size and shape as the screen of the transmitting computer, the window might be adjusted so as to fit comfortably in the screen of the receiving computer. However, the contents of the selected area of the screen of the transmitting computer and the window on the screen of the receiving computer might remain substantially the same.

The second broad portion of the invention allows a user to run software from one computer on another computer. This is done by placing the output of a software program into the selected area of the transmitting computer and allowing the user of the receiving computer to place input in the window of the screen of the receiving computer. For example, the user of the transmitting computer might run a spreadsheet program in the selected area and give the user of the receiving computer permission to make inputs into the window on the screen of the receiving computer. The user of the receiving computer may now make inputs into the spreadsheet by typing on the keyboard, clicking the mouse if one is available, etc., even if the receiving computer does not have any spreadsheet software. This is possible because all of the software related to the spreadsheet is running on the transmitting computer, while receiving input from, and providing output to, the receiving computer. Notice that, in one embodiment of the invention, when the user of the receiving computer makes a modification to the window on the screen of the receiving computer, an identical modification might be made to the user selected area of the screen of the transmitting computer. However, such a modification is not necessary, and another embodiment of the invention allows for no modification to be made to the screen of the transmitting computer in response to a modification of the window of the receiving computer. Similarly, when the user of the transmitting computer makes a modification to the selected area of the screen of the transmitting computer, an identical modification might be made to the window on the screen of the receiving computer. Alternatively, the image on the screen of the receiving computer might not change in response to a modification of the image on the screen of the transmitting computer.

### DETAILED DESCRIPTION OF THE INVENTION

There are two broad portions of this invention which complement each other to create a unique information sharing environment.

The first broad portion of this invention involves enabling two or more computer users to see a portion of each others computer screens in real time. Each computer might act as both a broadcaster and as a receiver simultaneously. When two or more computer users establish a connection or a session, each computer might act as both a broadcaster and a receiver. Two or more users may establish a connection when they use a communication program, which might be embedded in a text, voice, or video chat program, or might be used as a standalone application. To broadcast, a user may run the software associated with this invention and may use it to select an area of his computer screen. The user might move this selected area anywhere on his screen. The selection might now be captured and transmitted. The software might capture each pixel in the selected area and might transmit it in real time. The user receiving the image might see the transmitted image in a window on his computer screen. The same image that is in the transmitted area of the transmitting user's screen is in the window of the receiving user's screen. The information broadcasted could be static information, for example document text, or it could be dynamic information, for example video. This creates a virtual camera functionality on two or more computers.

The second broad portion of the invention might give the user of the receiving computer the ability to type from his computer and the text might appear on the user of the transmitting computer's opened documents. This might be done by the user of the transmitting computer placing a text document within the selected area of the user of the transmitting computer's computer screen and give the user of the receiving computer input permission. This tool also gives a user the capability of typing or free hand writing in his window box and allowing what he does to be seen on one or more computer screen by other users. The image could be transmitted over the internet or any other network or local wired or wireless communication device. The invention promises to be a very powerful tool for collaboration between two or more computer users. A few applications that come to mind are online training, group work and group study sessions, online computer repair, and remote document signing. In one embodiment of our invention the user has full control over what is sent to the other user(s) and what text can be received back. Unlike other technologies, which are used mostly for web conferencing, chat and network applications (games), our invention may be used for a user to send a segment of the user's computer screen to other user(s) and the transmitting user might be allowed to change the part of the screen that he transmits as he pleases. This way the transmitting user(s) might show the receiving user(s) only what the transmitting user(s) wants to show them and feel safe that the receiving user(s) do not have access to any part of the transmitting user's computer other than what is shown in the screen window. Also the user of the transmitting computer might give the user of the receiving computer the capability to type or draw on a very specific location on a computer file or program. The second might only see the document or portion of it and type or sign on the document by typing or using and electronic pen. The user of the receiving computer does not need the application that opened the document on the user of the receiving computer's computer. Our invention might take the data from the user of the receiving computer and insert it in the document opened by the user of the transmitting computer.

In one embodiment, the invention is platform independent and could run on multiple platforms, such as Windows, Macintosh and Linux.

In one embodiment of the invention, a user of the transmitting computer while connected to one or more contact(s) via a text, voice, or video chat application might initiate the screen broadcast utility by pressing on a control button on the chat box or calling a computer command in another way known to persons having ordinary skill in the act. On the user of the receiving computer's (the contact with whom the user of the transmitting computer is communicating) computer screen a static window of a similar size and shape might open. The user of the transmitting computer (the one who initiated the virtual camera function) can move the user selected area for transmission anywhere on his screen. When this window comes to rest, it might capture anything displayed within it and might transfer the image in real time to the user of the receiving computer's window. Notice due to transparent nature of the selected area of the screen, the user of the transmitting computer might also be able see also whatever is displayed in this selected area of the user of the transmitting computer's computer screen. This feature might behave as a virtual camera. Also due to possibility of different computer screen resolutions between the users, the data might be resized as it is transferred from one computer to another. The software checks the information within the selected area. For static information the image might be sent once so as to reduce the data transmitted between the users. For dynamic information, the image might be sent to the receiver in real time.

Another functionality that might be embedded in this utility is the keyboard functionality. The user of the transmitting computer can move the selected area of the screen over running software (for example a spreadsheet program) and give keyboard permission to the user of the receiving computer. At the other end, the user of the receiving computer can start typing on the chat keyboard entry box or use a pen and tablet for signature for free hand writing. The text the user of the receiving computer enters might show up on the user of the transmitting computer's screen and is transferred into the underlying document that was in the selected area. The user of the receiving computer does not need to have the application that has opened the document on the user of the transmitting computer's screen on own computer. This might be used, for example, by a lawyer who wishes for his remote client to sign a document. Notice that by combining this feature with a video communication program, the lawyer may witness his client signing the document.

This utility could also be used for broadcasting to a number of users. This might enable one user of the transmitting computer to share the information on his screen with a number of user of the receiving computers. The inclusion of voice and video available on instant messaging makes this feature a versatile tool for teaching and training.

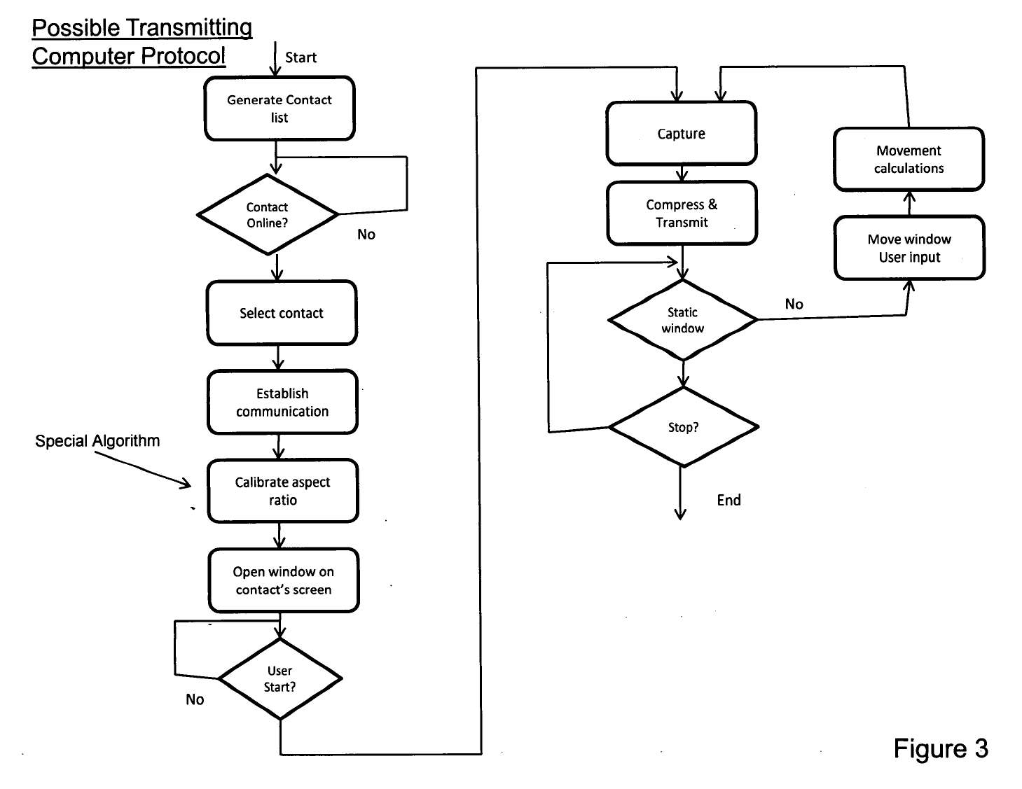

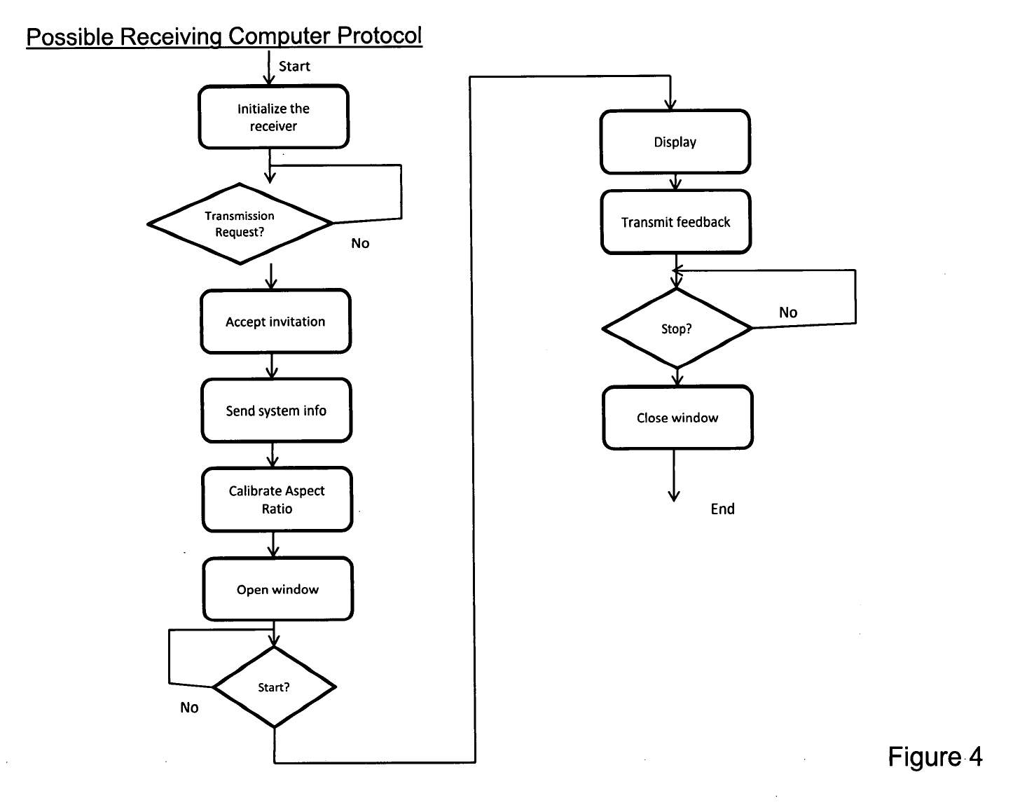

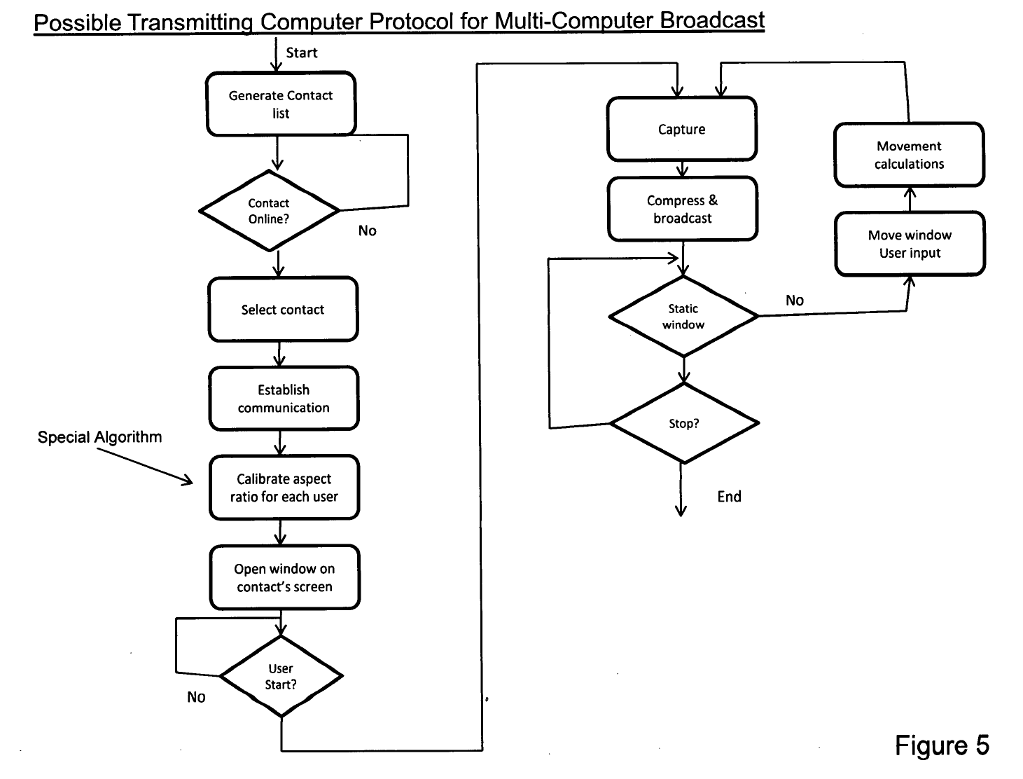

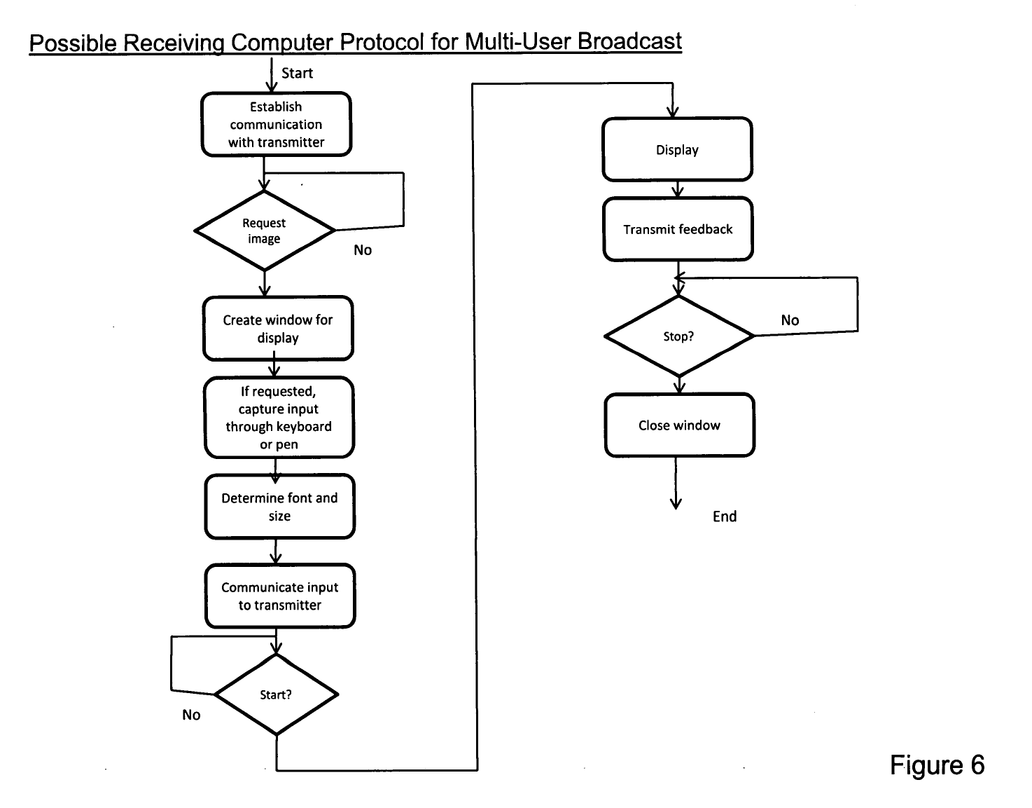

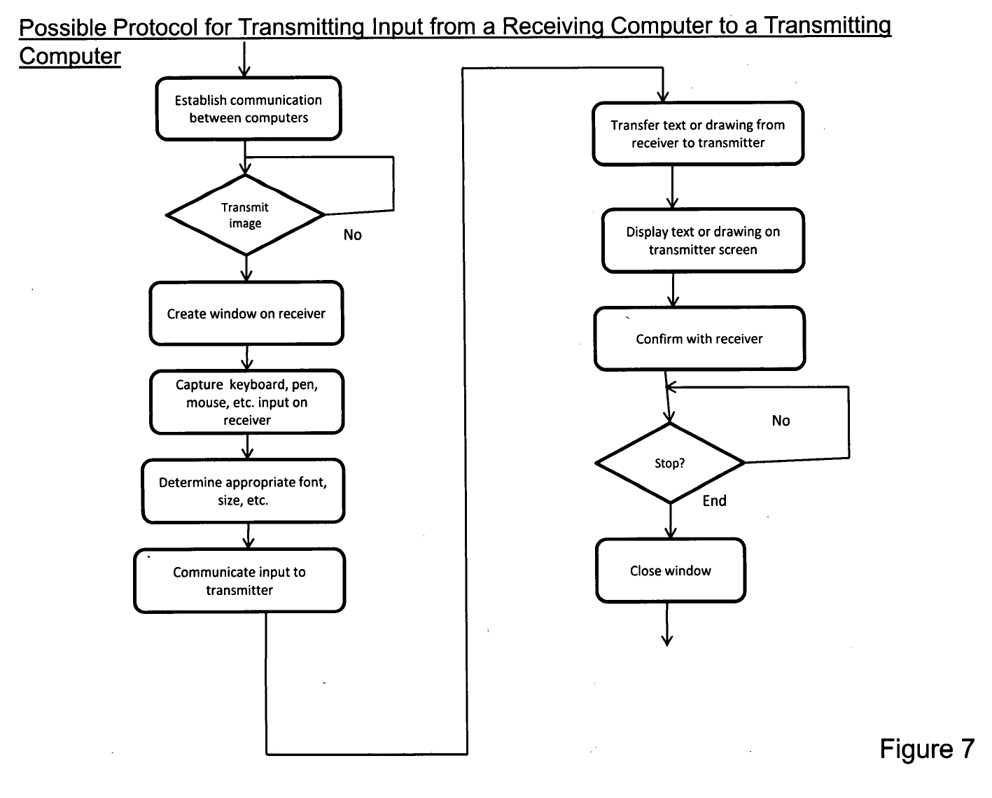

In one embodiment of the invention, as illustrated in FIG. 3, while using an instant messaging service, a user of the transmitting computer might initiate the screen broadcast utility by selecting an icon on the chat window. This would allow the user of the transmitting computer to select an area of his screen. After the user of the transmitting computer selects an area of the user of the transmitting computer's computer screen, a window might be created in the user of the receiving computer's screen, and the image might be displayed there, as shown in FIG. 4. The transmission rate for image transfer is bandwidth dependent, but the software might be optimized to enable video transmission. The software checks for static or dynamic content in the selected area of the user of the transmitting computer's screen. As long as the image is static, it is sent only once. For dynamic content, such as video or animation, the software might use the maximum transfer rate possible up to screen refresh rate to broadcast the images to the user(s) of the receiving computer(s). Also the software automatically adjusts for different screen resolution on user of the transmitting computer's computer screen and the user of the receiving computer's computer screen.

A great benefit of this invention is that the user of the receiving computer (the receiver) might not need to have the application that opened the document on the user of the transmitting computers' computer (transmitter). Assume the user of the transmitting computer opens a spreadsheet using a spreadsheet program. The user of the receiving computer might be able to see this spreadsheet even though he might not have any spreadsheet program on his computer.

The user of the transmitting computer might allow the user of the receiving computer to place input in the window. Whatever is typed or free hand written using a pen and tablet in this window could be transferred to the document or to the user selected area of the user of the transmitting computer's screen. For example, if the user of the transmitting computer selected a user selected area comprising a text document, the user of the receiving computer might be able to edit the document's text. For example, this might be useful when a client wishes to sign a document remotely at his lawyer office, or a system administer is setting up a client's personal computer remotely while the client is watching. The invention has an added advantage over VNC (virtual network computing) in that the user of the transmitting computer has full control of his computer and the user of the receiving computer only access the software that the user of the transmitting computer allows the user of the receiving computer to access.

This combination of image transfer, keyboard control, and text, voice, or video messaging creates a powerful communication tool for education, presentation and sharing.

### Description of the Preferred Embodiment

In a preferred embodiment, the invention might be used for communication between two personal computers over the internet. The invention might be used in conjunction with a text chat program or in conjunction with a voice or video chat program. This would allow the users of the two computers to communicate with each other while the screen sharing is going on. The invention might allow an instructor to demonstrate to students how to use new software, or allow students to experiment with software that they might not have installed on their machine. Also, it could be used for group projects, where several people might want to modify a single text document or spreadsheet, stored on only one computer, simultaneously.

### Conclusion

Certain exemplary embodiments have been described in detail and shown in the accompanying drawings, it is to be understood that such embodiments are merely illustrative of and not restrictive on the broad invention, and that this invention not be limited to the specific arrangements and constructions shown and described, since various other modifications may occur to those ordinarily skilled in the relevant art.

1: A method of connecting a substantially arbitrary transmitting computer and a substantially arbitrary receiving computer, wherein the receiving computer receives images from the transmitting computer, comprising the steps of:
selecting a substantially arbitrary transmitting computer comprising a screen, a keyboard, and a processor;
selecting a substantially arbitrary receiving computer comprising a screen, a keyboard, and a processor;
connecting the transmitting computer and the receiving computer, so as to allow communication between the transmitting computer and the receiving computer;
allowing a user of the transmitting computer to select a user selected area of the screen of the transmitting computer; and
creating a window on the screen of the receiving computer, wherein said user selected area of the screen of the transmitting computer is displayed.

2: The method in claim 1, wherein the selected substantially arbitrary transmitting computer is one of a personal computer, a cellular telephone, a blackberry or a PDA.

3: The method in claim 1, wherein the selected substantially arbitrary receiving computer is one of a personal computer, a cellular telephone, a blackberry or a PDA.

4: The method in claim 1, wherein the connecting the transmitting computer and the receiving computer is done through a network connection, such as an internet, cellular, or telephone connection.

5: The method in claim 1, wherein the connecting the transmitting computer and the receiving computer is done through a two-way connection, such as a wired or wireless connection.

6: The method in claim 1, wherein the user selected area of the screen of the transmitting computer comprises the display of at least one running application.

7: The method in claim 1, wherein the user selected area on the screen of the transmitting computer comprises the display of at least one running application, wherein a software to run the at least one running application is not available on the receiving computer.

8: The method in claim 1, further comprising the step of:
the user of the receiving computer modifying the contents of the window on the screen of the receiving computer.

9: The method in claim 1, further comprising the steps of:
the user of the receiving computer modifying the contents of the window on the screen of the receiving computer; and
a modification identical to the modification of the window on the screen of the receiving computer being made to the user-selected area of the screen of the transmitting computer.

10: The method in claim 1, further comprising the steps of:
the user of the transmitting computer modifying the contents of the user selected area of the screen of the transmitting computer; and
a modification identical to the modification of the contents of the user selected area of the screen of the transmitting computer being made in the window on the screen of the receiving computer.

11: An apparatus, such as a computer memory or computer-readable medium, for connecting a substantially arbitrary transmitting computer and a substantially arbitrary receiving computer, wherein the receiving computer is able to receive images from the transmitting computer, comprising:
a substantially arbitrary transmitting computer comprising a screen, a keyboard, and a processor;
a substantially arbitrary receiving computer comprising a screen, a keyboard, and a processor;
a means for connecting the transmitting computer and the receiving computer, so as to allow communication between the transmitting computer and the receiving computer;
a means for allowing a user to select an area of the screen of the transmitting computer; and
a means for creating a window on the screen of the receiving computer, wherein said user selected area of the screen of the transmitting computer is displayed.

12: The apparatus in claim 11, wherein the substantially arbitrary transmitting computer is one of a personal computer, a cellular telephone, a blackberry or a PDA.

13: The apparatus in claim 11, wherein the substantially arbitrary receiving computer is one of a personal computer, a cellular telephone, a blackberry or a PDA.

14: The apparatus in claim 11, wherein the means for connecting the transmitting computer and the receiving computer is a network connection, such as an internet, cellular, or telephone connection.

15: The apparatus in claim 11, wherein the means for connecting the transmitting computer and the receiving computer is a two-way connection, such as a wired or wireless connection.

16: The apparatus in claim 11, wherein the user selected area of the screen of the transmitting computer comprises the display of at least one running application.

17: The apparatus in claim 11, wherein the user selected area on the screen of the transmitting computer comprises the display of at least one running application, wherein a software to run the at least one running application is not available on the receiving computer.

18: The apparatus in claim 11, wherein the user of the receiving computer can modify the contents of the window on the screen of the receiving computer.

19: The apparatus in claim 11, wherein the user of the receiving computer can modify the contents of the window on the screen of the receiving computer, causing an identical modification to be made to the user-selected area of the screen of the transmitting computer.

20: The apparatus in claim 11, wherein the user of the transmitting computer can modify the contents of the user selected area of the screen of the transmitting computer, causing an identical modification to be made in the window on the screen of the receiving computer.
